(19) United States
(12) Patent Application Publication
(10) Pub. No.: US 2009/0113498 A1
(43) Pub. Date: Apr. 30, 2009

(54) Recorder and Content Management Method

(76) Inventor: Takayuki Yamamoto, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/255,773

(22) Filed: Oct. 22, 2008

(30) Foreign Application Priority Data
Oct. 25, 2007 (JP) 2007-277076

(51) Int. Cl. H04N 7/173

(52) U.S. Cl. 725/93

(57) ABSTRACT

A user can view a necessary content while a memory owned by the user does not need to have a large capacity. A problem with a copyright related to content is prevented. A recorder has a recording section and a VoD section. The recording section records content. The VoD section compares the content recorded by the recording section with content provided through a video-on-demand service, and removes the content recorded by the recording section based on the comparison. The recorder also has a receiving section and a reproduction content selector. The receiving section receives the content provided through the video-on-demand service. The reproduction content selector allows the receiving section to receive and reproduce the content provided through the video-on-demand service when the reproduction content selector receives an instruction for reproduction of the content removed by the VoD section.

### CLAIMS OF PRIORITY

The present application claims priority from Japanese patent application serial no. JP 2007-277076, filed on Oct. 25, 2007, the content of which is hereby incorporated by reference into this application.

### BACKGROUND OF THE INVENTION

The present invention relates to a recorder and a content management method, and more particularly to a recorder and a content management method, which support a video-on-demand (VoD) service.

Recording/reproducing devices have limited capacities to store contents. Studies have been carried out on recorders having limited capacities. In techniques described in JP-A-2000-13745 (Patent Document 1), JP-A-2001-350631 (Patent Document 2), and JP-A-2005-64997 (Patent Document 3), when an available memory area is reduced, a recorded content is re-encoded in order to reduce a bit rate for storage of content and increase the available memory area. In a technique described in JP-A-8-56352 (Patent Document 4), recorders cooperate with each other and are controlled to prevent to redundantly record the same content so as to efficiently utilize the total memory area of the recorders. In techniques described in JP-A-11-331716 (Patent Document 5), JP-A-2002-140541 (Patent Document 6), and JP-A-2003-223425 (Patent Document 7), a device such as a server is remotely instructed to record content, acquires the content through a network or the like when necessary, and records the content without using a memory area of a memory provided in a device such as a recording/reproducing device. In techniques described in JP-A-2000-244555 (Patent Document 8), JP-A-2003-141420 (Patent Document 9), JP-A-2003-153164 (Patent Document 10), and JP-A-2004-328603 (Patent Document 11), content recorded in a recording/reproducing device or the like is automatically transferred to a server or the like to ensure a sufficient available memory area of a memory provided in the device.

### SUMMARY OF THE INVENTION

In the techniques described in Patent Documents 1 to 3 in which a recorded content is re-encoded in order to increase an available memory area, the quality of an image may be reduced, and the available memory area is generally increased by only several times. In the technique described in Patent Document 4 in which the devices cooperate with each other to record content, it is necessary that a user have a sufficient memory area. In the techniques described in Patent Documents 5 to 7 in which the server or the like is remotely operated to record content, when the server is owned by a certain user, it is necessary that the user have a sufficient memory area. When the server is not owned by the user, a problem with a copyright related to the content may arise. In the techniques described in Patent Documents 8 to 11 in which the recorded content is transferred to the server, when the server is owned by a user, it is necessary that the user have a sufficient memory area. When the server is not owned by the user, a problem with a copyright related to the content may arise.

It is therefore an object of the present invention is to provide a technique for solving the abovementioned problems.

To accomplish the object, a recorder has: a recording section for recording content; and a video-on-demand (VoD) section. The VoD section compares the content recorded by the recording section with content provided through a video-on-demand service and removes the content recorded by the recording section based on the comparison.

The recorder allows a user to view a necessary content while a memory owned by the user does not need to have a large capacity. A problem with a copyright related to content is prevented.

### BRIEF DESCRIPTION OF THE DRAWINGS

FIG. 1 is a block diagram showing an example of the configuration of a system and the configuration of a recording/reproducing device.

FIG. 2 is a flowchart showing an example of a process from initial settings to the start of a VoD enabling process.

FIG. 3 is a flowchart showing an example of a process after the start of the VoD enabling process.

FIG. 4 is a flowchart showing an example of a process in the case where a recording/reproducing device receives a content removal notification from a VoD server.

FIG. 5 is a flowchart showing an example of a process in the case where a user instructs the recording/reproducing device to reproduce content.

FIG. 6 is a flowchart showing an example of a process for determining whether or not the VoD enabling process is possible.

FIG. 7 is a diagram showing a data table that indicates an example of meta data of content published by a VoD server.

FIG. 8 is a schematic diagram showing an example of a screen displayed by a reproduction content selector.

FIG. 9 is a diagram showing a data table that indicates an example of content meta data held by the reproduction content selector.

FIG. 10 is a schematic diagram showing an example of a screen used to determine whether or not content matches VoD content for the VoD enabling process.

FIG. 11 is a diagram showing an example of a screen indicating, in an electronic program guide, that the VoD enabling process is possible.

FIG. 12 is a diagram showing an example of a screen indicating, in an operation screen for programmed recording, that the VoD enabling process is possible.

FIG. 13 is a diagram showing an example of information indicating a difference between a broadcast content and VoD content.

### DESCRIPTION OF THE PREFERRED EMBODIMENT

An embodiment of the present invention is described below with reference to the accompanying drawings.

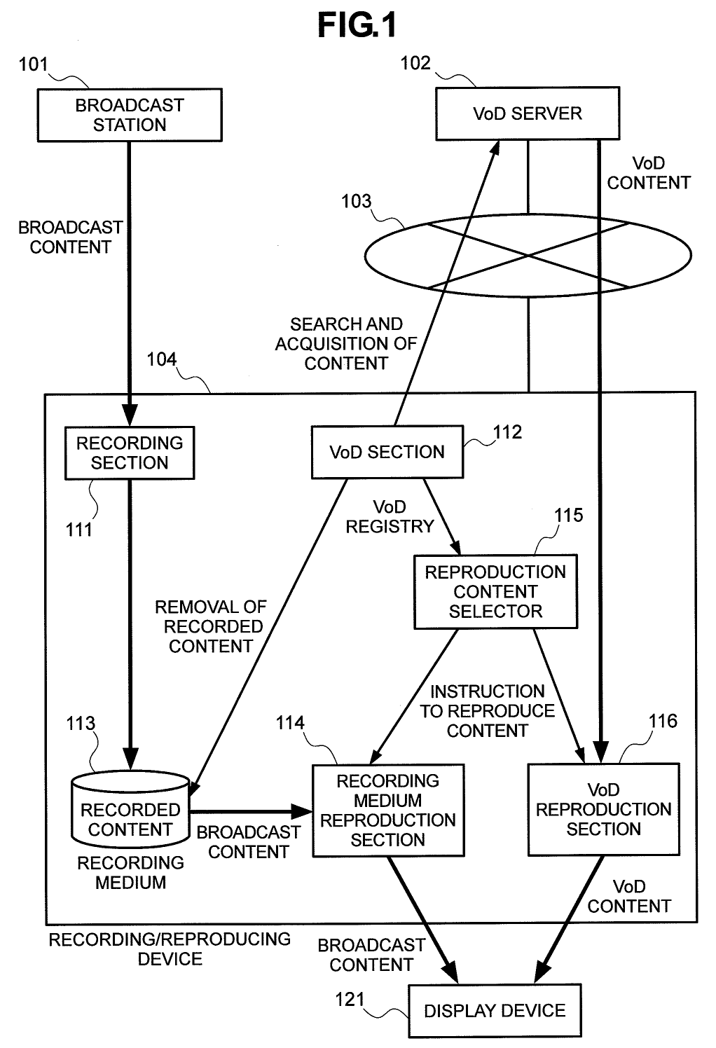

FIG. 1 shows an example of the configuration of a system having a recording/reproducing device 104, a broadcast station 101, and a video-on-demand (VoD) server 102. The broadcast station 101 provides content to the recording/reproducing device 104. The content is, for example, a program including video and audio data.

The broadcast station 101 mainly uses a broadcast wave to transmit content to the recording/reproducing device 104. The VoD server 102 transmits content through a network to the recording/reproducing device 104. The broadcast station 101 and the VoD server 102 may be owned by the same content provider. The VoD server 102 may be located in the broadcast station 101. Reference numeral 103 denotes a broadband network. The broadband network 103 is connected with the VoD server 102 and the recording/reproducing device 104.

The recording/reproducing device 104 is a HDD/optical disc recorder, a computer, a mobile phone or the like. It is not necessary that the recording/reproducing device 104 have both a recording function and a reproducing function. The recording/reproducing device 104 may have either one of the recording function and the reproducing function. The recording/reproducing device 104 has a communication interface, a video output interface, an antenna for broadcast reception, and a tuner for broadcast reception. The recording/reproducing device 104 also has one or more of CPUs, one or more of LSI circuits, a semiconductor memory for storing data, and a hard disk drive (HDD). In addition, the recording/reproducing device 104 includes hardware such as a reader and a writer. The reader reads data stored in the semiconductor memory and the HDD. The writer writes data in the semiconductor memory and the HDD. In FIG. 1, some of the abovementioned parts are not drawn. A recording section 111, a VoD section 112, a recording medium reproduction section 114, a reproduction content selector 115, and a VoD content reproducing section 116 may be respectively realized by a LSI circuit, or by a CPU that executes software.

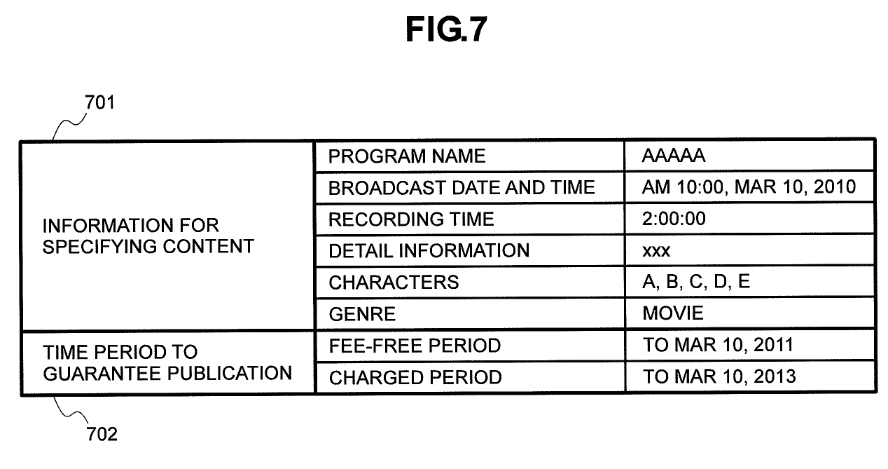

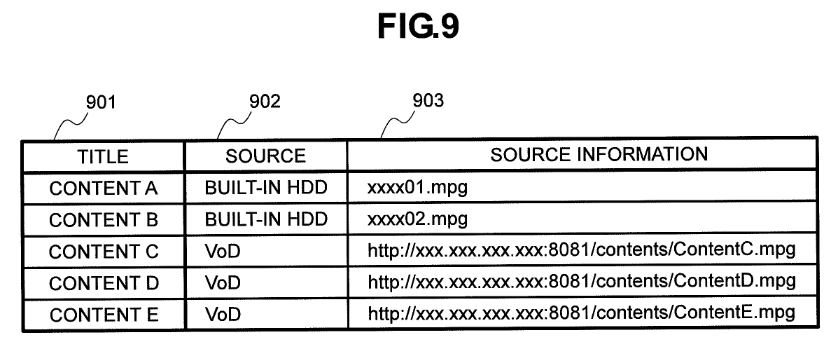

Content is recorded by the recording section 111 and stored in a recording medium 113 (that is, for example, a hard disk). Meta data of the content stored in the recording medium 113 is described later with reference to FIG. 9. The reproduction content selector 115 selects a recorded program. The reproduction content selector 115 is used to select a recorded content and reproduce the content. The content that is stored in the recording medium 113 and selected by the reproduction content selector 115 is reproduced by means of the recording medium reproduction section 114. In this case, the content is displayed by a display device 121. An example of a display screen is described later with reference to FIG. 7. In the configuration of the system, the display device 121 and the recording/reproducing device 104 are separated from each other. However, the display device 121 and the recording/reproducing device 104 may be provided in a single device.

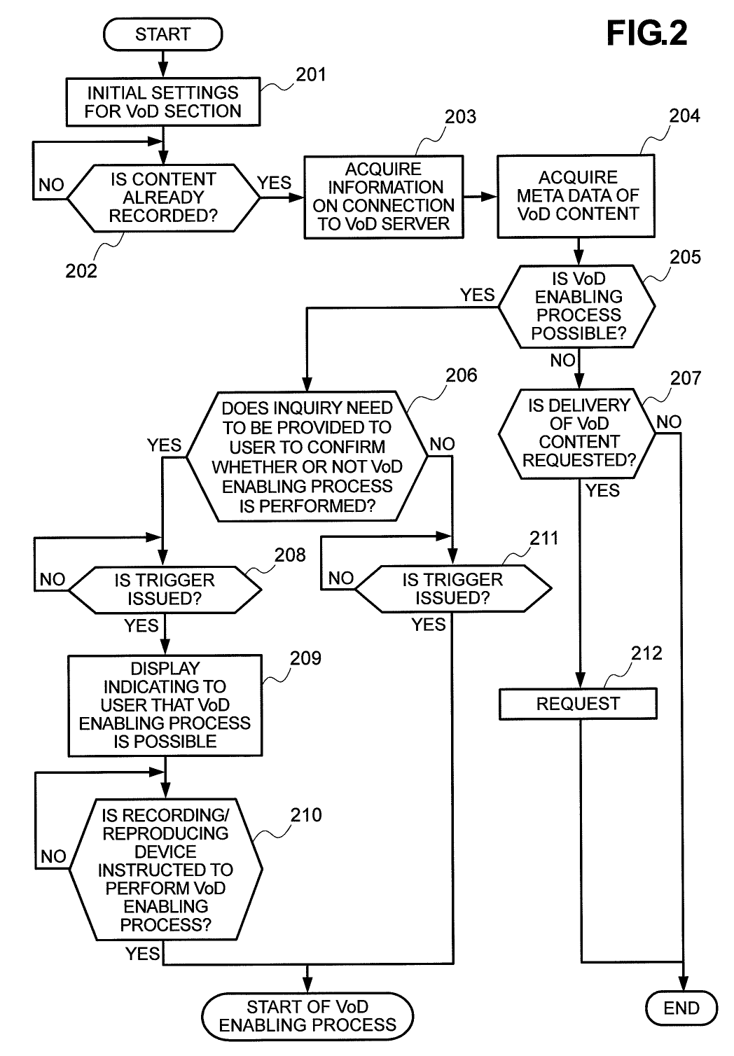

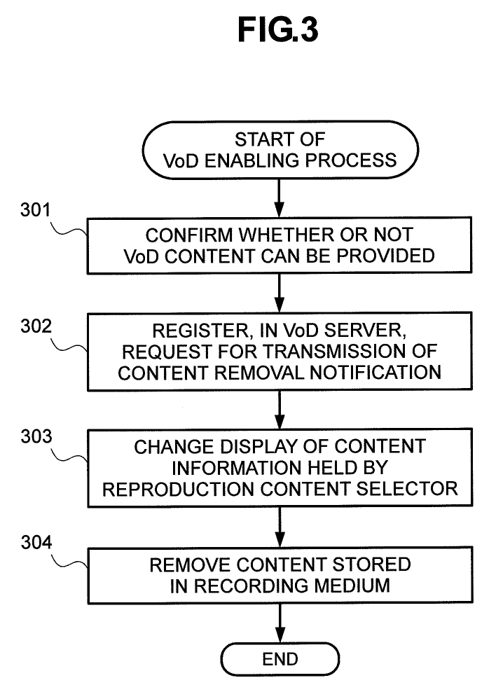

The VoD section 112 compares content recorded in the recording medium 113 with content provided by the VoD server 102. When the VoD server provides content corresponding to the recorded content, the VoD section 112 removes the content stored in the recording medium 113. In this case, the VoD section has a link (to the VoD server) to reproduce the content instead of the removed content. The link is hereinafter referred to as a reproduction link. In a VoD enabling process, a recorded content is removed, and VoD content is reproduced instead of reproduction of the recorded content. The VoD section 112 is described later with reference to FIGS. 2 and 3.

The reproduction content selector 115 presents, to a user, content stored in the recording medium 113 and a reproduction link and serves as a section for selecting content and reproducing the content. When content stored in the recording medium 113 is selected, the content is reproduced from the recording medium 113. When content is selected by the reproduction content selector 115 and provided by means of the reproduction link, the content is reproduced by the VoD reproduction section 116. The reproduction content selector 115 is described later with reference to FIGS. 3 to 5.

The VoD server 102 transmits VoD content based on a request provided from the VoD reproduction section 116. The VoD reproduction section 116 acquires content through the network from the VoD server 102 and reproduces the content. The VoD reproduction section 116 causes the display device 121 (which is a liquid crystal display, a plasma display panel or the like) to display the content.

FIG. 7 shows an example of meta data of a single content provided through a video-on-demand service by the VoD server 102. The VoD server 102 stores content meta data for the number of contents. The content meta data is mainly divided into two types of data: information 701 for specifying the content; and information 702 on a time period to guarantee the publication of the content.

The information 701 for specifying content is used to confirm the identification of the content. It is assumed that the meta data of content recorded by the recording/reproducing device 104 includes a program name and detail information and that a broadcast date, a broad cast time, and a recording time can be acquired before the recording of the content. In this case, when content meta data acquired from the broadcast station 101 matches content meta data published by the VoD server 102, it is determined that the content published by the VoD server 102 and the content broadcasted by the broadcast station 101 are the same as each other.

The information 702 on the time period to guarantee the publication of content indicates a time period for which the content can be acquired through the video-on-demand service. For example, when the time period to guarantee the publication of content for free is only three days, the VoD enabling process is not effective. Information 702 on the time period to guarantee the publication may be presented to a user in steps 206, 607 and the like (described later). When the time period to guarantee the publication of the content is shorter than a predetermined period of time (e.g., one month or more (the predetermined period of time can be changed by the user)), the system may be configured to ensure that the content is not VoD enabled (the content cannot be replaced with VoD content).

FIG. 9 shows an example of content meta data held by the reproduction content selector 115. Reference numeral 901 denotes the title of content. Reference numeral 902 denotes a source of the content. The source 902 of the content indicates “Built-in HDD” (which means the recording medium 113) or “VoD” (which means the VoD server 102). Reference numeral 903 denotes information on the source 902. When the source 902 indicates “Built-in HDD”, the information 903 indicates a file name of the content. When the source 902 indicates “VoD”, the information 903 indicates a uniform resource locator (URL) for the content. It should be noted that the data shown in FIG. 9 may include other data.

FIG. 2 is a flowchart of an example of a process from initial settings for the VoD section 112 to the start of the VoD enabling process. When the process shown in FIG. 2 starts, the initial settings for the VoD section are carried out in step 201. In the initial settings, whether or not the VoD enabling process is performed is set (for step 206); whether or not an inquiry is provided to a user for the VoD section is set when VoD content is charged; whether or not the VoD enabling process is progressed without the inquiry to the user is set when the VoD content is charged and the fee for the VoD content is equal to or less than a certain amount of money (for step 206); a condition (for example, a condition under which a remaining memory capacity is equal to or smaller than a certain capacity) for a trigger for starting the VoD enabling process is set (for steps 208 and 211); and when VoD content corresponding to a recorded content is not present in the VoD server, a request for providing VoD content corresponding to the recorded content to the VoD server is set (for step 207).

Next, it is determined whether or not content is recorded in step 202. When the content is recorded (the determination in step 202 is affirmative), the process shown in FIG. 2 proceeds to step 203. It should be noted that even when the content is not recorded in step 202, the process may proceed to step 203 and step 204 before the recording starts in order to acquire information (hereinafter also called connection information) on a connection to the VoD server or acquire a VoD content list.

Next, the information on the connection to the VoD server is acquired in step 203. The information on the connection to the VoD server is used to connect the recording/reproducing device 104 to the VoD server. The connection information includes information (e.g., a URL) that allows a device to be specified on the network, information that allows an application to be specified on the device, and other additional information. For example, the recording/reproducing device 104 may reference a directory server (providing a directory service) having the information (on the connection to the VoD server) registered therein in order to acquire the connection information. Alternatively, the connection information may be acquired from data preset in the recording/reproducing device 104. Alternatively, the recording/reproducing device 104 may register multicast delivery in the network and acquire the connection information through the multicast delivery. Alternatively, data on a method for the connection to the VoD server may be acquired from (shared with) another recording/reproducing device. Alternatively, a user sets the connection information in the recording/reproducing device 104.

Next, meta data of VoD content is acquired in step 204. An example of the meta data is shown in FIG. 7. In step 204, meta data of all contents that can be provided by the VoD server 102 is acquired. Alternatively, in step 204, meta data of content recorded by the recording/reproducing device 104 is provided to the VoD server 102, and meta data of VoD content corresponding to the content provided to the VoD server 102 is acquired. It should be noted that a VoD content list may not be acquired from the VoD server 102 and may be acquired from the directory server or another server.

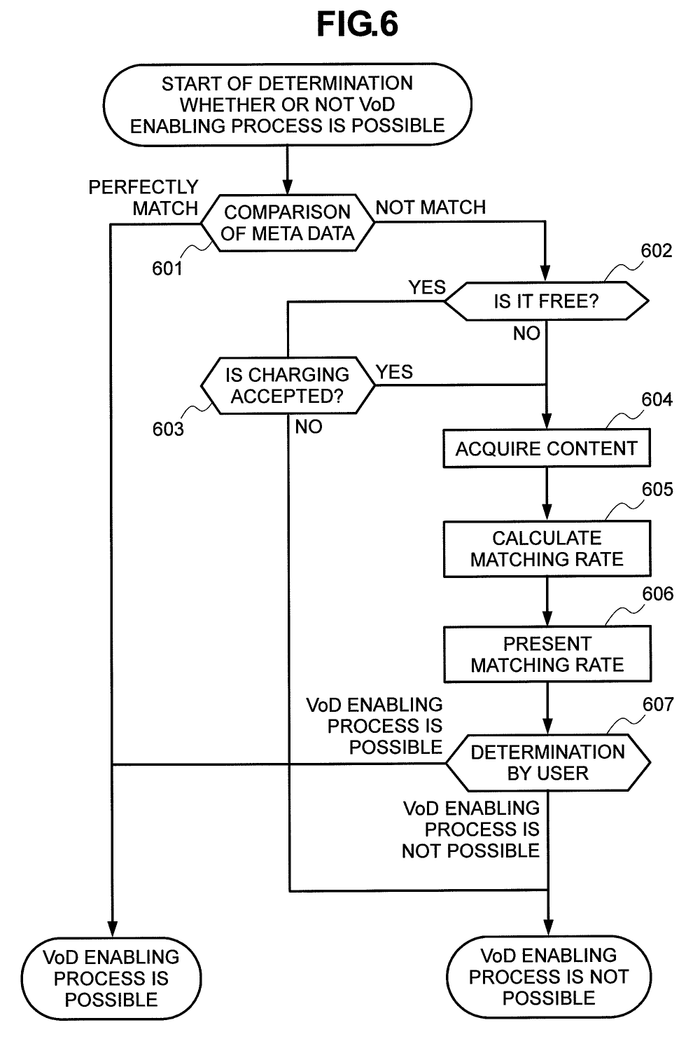

Next, the recording/reproducing device 104 determines whether or not the recorded content is VoD enabled (or whether or not the recorded content can be replaced with VoD content) in step 205. In order to determine whether or not the recorded content can be replaced with the VoD content, it is confirmed whether or not the VoD enabling process is permitted to be performed (through an inquiry to the user in some cases) using the conditions set in step 201. For example, in order to determine whether or not the recorded content can be replaced with the VoD content, it is confirmed whether or not the VoD content perfectly matches the recorded content or whether or not the user permits the VoD enabling process when the VoD content does not partially match the recorded content. Step 205 is described later with reference to FIG. 6.

When the recording/reproducing device 104 determines that the VoD enabling process is possible in step 205 (when the determination in step 205 is affirmative), the process shown in FIG. 2 proceeds to step 206. In step 206, it is determined based on the initial settings in step 201 whether or not the inquiry needs to be provided to the user. In the case where it is determined that the inquiry needs to be provided to the user, the initial settings are already carried out to ensure that the inquiry is provided to the user when the VoD enabling process needs to be performed or when a specified condition is met. The specified condition is, for example, that the frequency of reproductions of the content is higher than that of reproductions of another content. When it is determined that the inquiry needs to be provided to the user, step 208 is performed. When it is determined that the inquiry does not need to be provided to the user, step 211 is performed.

In each of steps 208 and 211, a trigger is issued when an available memory area of the recording medium is smaller than a certain amount or after a predetermined time elapses. The issuance of the trigger is to provide a command or provide a trigger, for example.

When the trigger is issued in step 208, display is performed to indicate to the user whether or not the VoD enabling process is possible in step 209. The display indicates to the user whether or not the content is VoD enabled (whether or not the VoD enabling process can be performed on the content). In addition, the display provides a user interface that allows the user to instruct the recording/reproducing device 104 to perform the VoD enabling process. When the user instructs the recording/reproducing device 104 to perform the VoD enabling process (determination in step 210 is affirmative), the recording/reproducing device 104 performs the VoD enabling process. When the determination in step 210 is negative, the recording/reproducing device 104 waits for an instruction. However, the recording/reproducing device 104 may not perform the VoD enabling process (may determine that the VoD enabling process is not possible) or may terminate the process shown in FIG. 2 after a predetermined time elapses.

When the trigger is issued in step 211, the VoD enabling process is started.

In step 207, it is determined based on the initial settings whether or not a request for delivering the VoD content through the VoD service is provided. When it is determined that the request is provided, meta data of the recorded content and the like is transmitted to the VoD server, and the request for delivering the content through the VoD service is provided to the VoD server in step 212. The process is then ended. When it is determined that the request is not provided in step 207, the process is directly ended.

The process shown in FIG. 2 may start from or end any of steps 201 to 212. For example, if the initial settings are once carried out in step 201, it is not necessary that step 201 be performed unless the user requests the settings.

Step 205 is performed on a single content. When step 205 is performed on a plurality of contents, steps 205 to 212 are performed a plurality of times for the number of the contents.

When the VoD server 102 can provide the requested content through the VoD service, the VoD server 102 may transmit, to the recording/reproducing device 104 that requests in step 212, a notification for the start of providing the VoD content. After the recording/reproducing device 104 receives the notification for the start of providing the VoD content from the VoD server 102, the recording/reproducing device 104 performs step 205 when the notification includes meta data of the content. When the notification does not include the meta data of the content, the recording/reproducing device 104 performs step 204.

FIG. 3 is a flowchart showing an example of a process after the VoD enabling process starts in FIG. 2. After the VoD enabling process starts, the recording/reproducing device 104 confirms whether or not the content present in the VoD server 102 can be provided through the VoD service in step 301. In step 301, the recording/reproducing device 104 confirms whether or not information (included in the content meta data acquired in step 204) on the acquisition of the content is correct. The method for the confirmation is not limited as long as the recording/reproducing device 104 can confirm whether or not the content can be acquired. For example, a HEAD method of the Hyper Text Transfer Protocol (HTTP) may be used as the method for the confirmation. Step 301 is not mandatory. However, step 301 is performed to reduce the possibility in which the content cannot be reproduced in step 502 (in which VoD is actually performed).

Next, a request for transmission of a content removal notification is registered in the VoD server 102 in step 302. The content removal notification is transmitted from the VoD server 102 to the recording/reproducing device 104 before the delivery of the VoD content from the VoD server 102 is terminated (before the VoD service is suspended). The content removal notification is provided to notify the recording/reproducing device 104 of the termination of the delivery of the VoD content (or notify the recording/reproducing device 104 of the suspension of the VoD services). The request for transmission of the content removal notification is registered in the VoD server in step 302 to ensure that the recording/reproducing device 104 can receive the content removal notification.

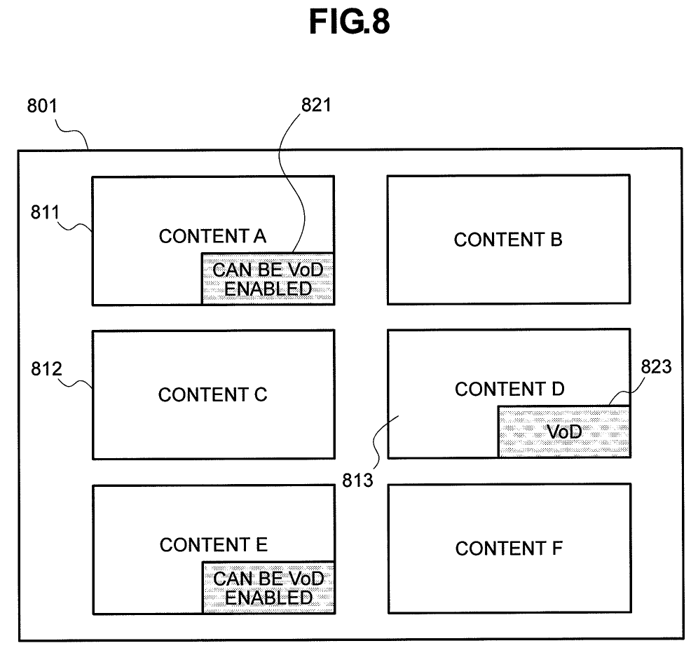

Next, the source (shown in FIG. 9) of the content meta data held by the reproduction content selector 115 is changed to “VoD” in step 303. When the source is changed to “VoD”, information indicating that a corresponding content is replaced with VoD content is displayed in a reproduction content selection screen. In addition, the VOD content is reproduced instead of selection for reproduction of the corresponding content. In this case, a character (refer to 823 shown in FIG. 8) or a picture, which indicates the VoD content, may be displayed for the content replaced with the VoD content on the user interface (on which the content is selected for reproduction).

Next, the content stored in the recording medium is removed in step 304.

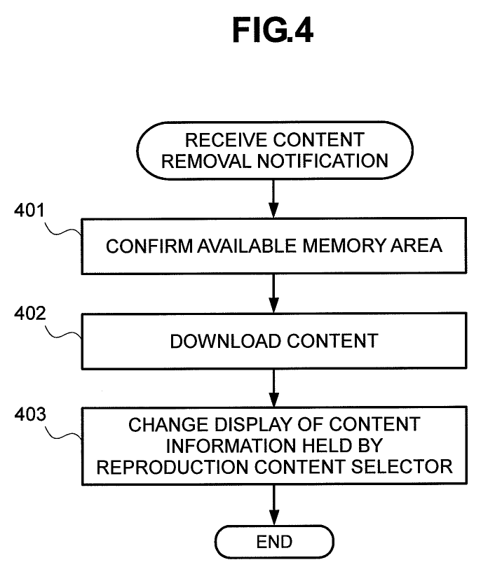

FIG. 4 is a flowchart showing an example of a process performed when the recording/reproducing device 104 receives the content removal notification from the VoD server 102. The content removal notification is received by the recording/reproducing device 104 from the VoD server 102 in the case where the content registered in step 302 is scheduled to be removed (or in the case where the VoD service is scheduled to be suspended). When the recording/reproducing device 104 receives the content removal notification, the recording/reproducing device 104 confirms the available memory area of the recording medium in step 401. The available memory area is information on a data amount, reproduction time or the like of the content that can be recorded. The available memory area may indicate a time for reproduction of content that can be recorded or a data amount of content that can be recorded. When the available memory area confirmed in step 401 is not sufficient, the recording/reproducing device 104 may present, to the user, a message prompting the user to create an available memory area. In addition, the recording/reproducing device 104 may request, to the VoD server 102, content having a bit rate appropriate for the available memory area or may change the bit rate or format of the downloaded content in the recording/reproducing device 104.

When the available memory area is sufficient to download VoD content, the recording/reproducing device 104 downloads the VoD content in step 402. The download of the content is to record the content provided through the VoD service into the recording medium 113.

Next, the source (shown in FIG. 9) of the content meta data held by the reproduction content selector 115 is changed to “Built-in HDD” (recording medium 113). When the source of the content meta data is changed to “Built-in HDD”, the content information changed in step 303, which is held by the reproduction content selector 115 and indicates that the content is already replaced with the VoD content, is removed or changed to information indicating that the content is reproduced by a terminal.

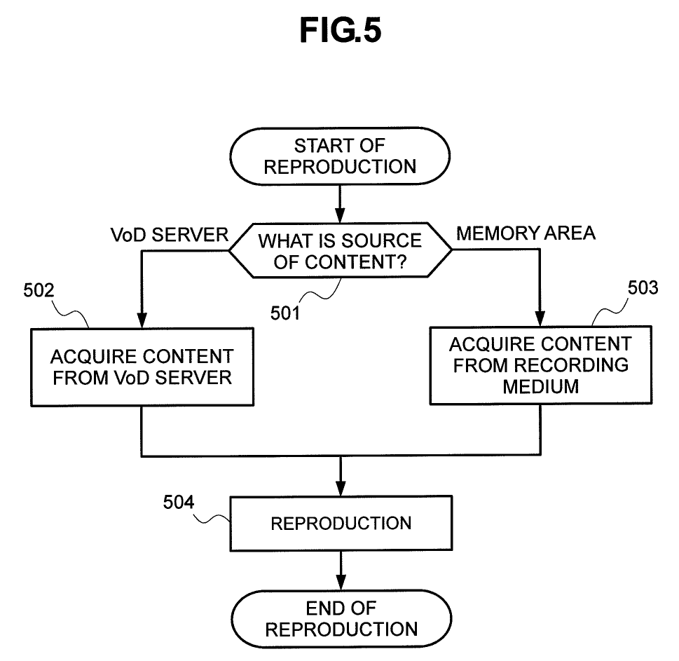

FIG. 5 is a flowchart showing an example of a process in the case where the user instructs the recording/reproducing device 104 to reproduce the content. When the reproduction content selector 115 selects content and reproduces the content, the reproduction content selector 115 determines the source of the content based on the source (shown in FIG. 9) of the content meta data in step 501.

When the content is present in the VoD server 102, the recording/reproducing device 104 acquires the content from the VoD server 102 in step 502 and reproduces the content in step 504.

When the content is present in the recording medium 113, the recording/reproducing device 104 acquires the content from the recording medium 113 in step 503 and reproduces the content in step 504.

FIG. 6 is a flowchart showing a detail example of a process for determining whether or not the VoD enabling process is possible in step 205. In FIG. 6, it is determined whether or not the recorded content to be VoD enabled (or to be replaced with VoD content) is the same as the content present in the VoD server 102. When the process shown in FIG. 6 starts, it is determined in step 601 whether or not the recorded content is the same as the content provided by the VoD server based on the content meta data acquired in step 204.

As a method for determining whether or not the recorded content is the same as the content provided by the VoD server, for example, the broadcast station 101 may provide information to guarantee the identity of the content. For example, the meta data provided in step 204 includes information such as the broadcast date, the broadcast time, and broadcast channel. In this case, the recording/reproducing device 104 includes the same information as the meta data of the recorded content, it may be determined that the recorded content to be VoD enabled is the same as the content present in the VoD server. An ID for specifying a program is delivered simultaneously with the broadcast content, and the meta data of the content provided by the VoD server includes the same ID. In this case, since the IDs are the same as each other, it can be determined that the recorded content to be VoD enabled is the same as the content provided by the VoD server. The recording/reproducing device 104 may transmit the meta data of a recorded content to the VoD server 102, and the VoD server 102 may determine whether or not the recorded content is the same as the content present in the VoD server 102. In this case, the VoD server 102 transmits the result of the determination to the recording/reproducing device 104. The recording/reproducing device 104 may transmit a fingerprint of the content to the VoD server 102 instead of the meta data of the content. The fingerprint is a part of the content. For example, a hush function is used to compress data having one megabyte into data (fingerprint) having one byte. Data having four gigabytes can be represented by data having four kilobytes. The VoD server 102 crosschecks the fingerprint transmitted by the recording/reproducing device 104 with a fingerprint of content present in the VoD server 102. Therefore, the VoD server 102 can substantially guarantee the identity of the content by means of a small amount of data.

When the recorded content perfectly matches the content present in the VoD server 102 in step 601, it is determined that the VoD enabling process is possible (the recorded content is VoD enabled). It should be noted that even when the recorded content perfectly matches the content present in the VoD server 102 in step 601, it may be determined whether or not the VoD enabling process is possible after step 602 is performed to determine whether or not the content is free or charged and after step 603 is performed to determine whether or not the charging is acceptable.

On the other hand, when the recorded content does not match the content present in the VoD server 102 in step 601, it is determined whether or not the recorded content is compared with the content present in the VoD server 102. The comparison of the contents is to present to the user information to determine whether or not the recorded content is replaced with the content present in the VoD server and to prompt the user to make a determination. This results from the fact that since there is a small difference between the recorded content and the content present in the VoD server 102, it is not determined whether or not the recorded content is replaced with the content present in the VoD server 102.

In the comparison of the contents, since the content is actually acquired, it is determined whether the acquisition of the content is charged or free in step 602.

When the acquisition of the content is charged, it is determined whether or not charging for the comparison of the contents is acceptable in step 603. As a method for determining whether or not the charging for the comparison of the contents is acceptable, a setting value in step 201 indicating that the charging is acceptable may be preset. Alternatively, a setting value may be set, which indicates that the charging is acceptable under the condition that the charge is equal to or less than a predetermined amount of money. Alternatively, an inquiry may be provided to the user in order to determine whether or not the charging is acceptable.

When the content is charged and the charged comparison of the contents is not possible (determination in step 603 is negative), it is determined that the VoD enabling process is not possible.

When the charging is acceptable (the determination in step 603 is affirmative) or when the content is free (determination in step 602 is affirmative), the recording/reproducing device 104 acquires the content in step 604.

The recording/reproducing device 104 compares video data of the recorded content with video data of the content acquired from the VoD server 102 and/or compares audio data of the recorded content with audio data of the content acquired from the VoD server 102 to specify a matching portion and to thereby calculate the matching rate in step 605.

The recording/reproducing device 104 presents the result of the calculation to the user in step 606.

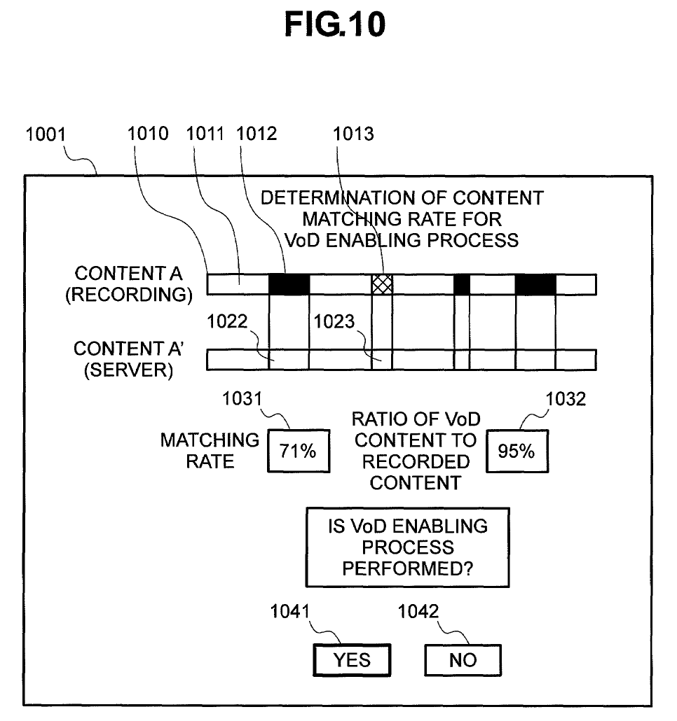

FIG. 10 shows an example of a screen indicating the result of the calculation. Reference numeral 1001 denotes a match determination screen. In FIG. 10, a recorded content A is compared with content A′ held by the VoD server 102. A longitudinal axis of a bar 1010 indicates time. The leftmost side of the longitudinal axis indicates the start point of the content, while the rightmost side of the longitudinal axis indicates the end point of the content. Reference numeral 1011 denotes a portion of the recorded content A, which matches a portion of the content A′. Reference numeral 1012 denotes a portion of the recorded content A, which does not correspond to a portion 1022 of the content A′. Reference numeral 1013 denotes a portion of the recorded content A, which does not correspond to a portion 1023 of the content A′ and is different from the portion 1023. Reference numeral 1031 denotes a matching rate between the recorded content A and the content A′ held by the VoD server 102. The method for calculation of the matching rate may use a generally used method. Reference numeral 1032 denotes a ratio of the content A′ held by the VoD server 102 to the entire recorded content A. In this example, a portion of the recorded content A other than the portion 1013 is included in the content held by the VoD server 102. Therefore, in order to calculate the ratio 1032, a ratio of the portion of the recorded content A other than the portion 1013 to the entire recorded content A is calculated.

When the recording/reproducing device 104 receives data (indicating that the VoD enabling process is permitted) entered by the user based on the result of the calculation in step 607, the VoD enabling process is possible. When the recording/reproducing device 104 receives data (indicating that the VoD enabling process is not permitted) entered by the user, the VoD enabling process is not possible and the process is ended. In step 607, the user enters the data to determine whether or not the VoD enabling process is possible. However, a program or the like may be used to determine whether or not the VoD enabling process is possible.

In the VoD enabling process, the entire recorded content may not be replaced with VoD content. A portion of the recorded content may be replaced with a portion of VoD content and stored in the built-in HDD. For example, if the entire recorded content A shown in FIG. 10 were replaced with the VoD content, the portion 1013 of the content A would be lost. Thus, the only the portion 1013 of the content A is stored in the built-in HDD, and the other portion of the content A is replaced with a portion of the VoD content. In this case, the source of the content meta data held by the reproduction content selector indicates “Built-in HDD” and “VoD”. Source information 903 shown in FIG. 9 indicates a file and a URL. In order to seamlessly connect the content portion obtained from the file with the content portion obtained through the URL, data indicating the position (corresponding to time information of reproduction of the content portion) of the content portion obtained from the file and data indicating the position of the content portion requested through the URL are stored in the recording/reproducing device 104.

In FIGS. 2 to 6, the trigger is used in steps 208 and 211 as a cue for the VoD enabling process. The trigger may be used according to an instruction from the user. FIG. 8 is a diagram showing an example of a screen 801 displayed by the display device 121. The screen 801 indicates reproduction of content and is used to select the VoD enabling process. Six contents A to F are displayed on the screen 801. The contents other than the content D are recorded contents, while the content D is reproduced through the reproduction link. The content A is VoD enabled (the content can be replaced with VoD content). In the state shown in FIG. 8, however, the content A is not replaced with the VoD content. The content A is displayed with a sign “VoD enabled” (indicated by reference numeral 821 in FIG. 8). In this case, when data indicating “VoD enabled” is entered, the recording/reproducing device 104 performs step 301 and the subsequent steps to cause the content A to be replaced with VoD content. When an instruction is provided to reproduce the content A, the content A is reproduced in the same manner as reproduction from the built-in HDD. The content C (indicated by reference numeral 812 in FIG. 8) is not VoD enabled (the content C cannot be replaced with VoD content) and is not VoD content. The content C is a normal recorded content. The content D is a VoD enabled content as displayed with a sign “VoD” (indicated by reference numeral 823 in FIG. 8). The content D is reproduced through the reproduction link. When an instruction for reproduction is provided to the content D, VoD reproduction starts.

In the configuration described above, a recorded content is VoD enabled (the recorded content can be replaced with VoD content) through an easy operation. This results in saving of the memory area of the HDD.

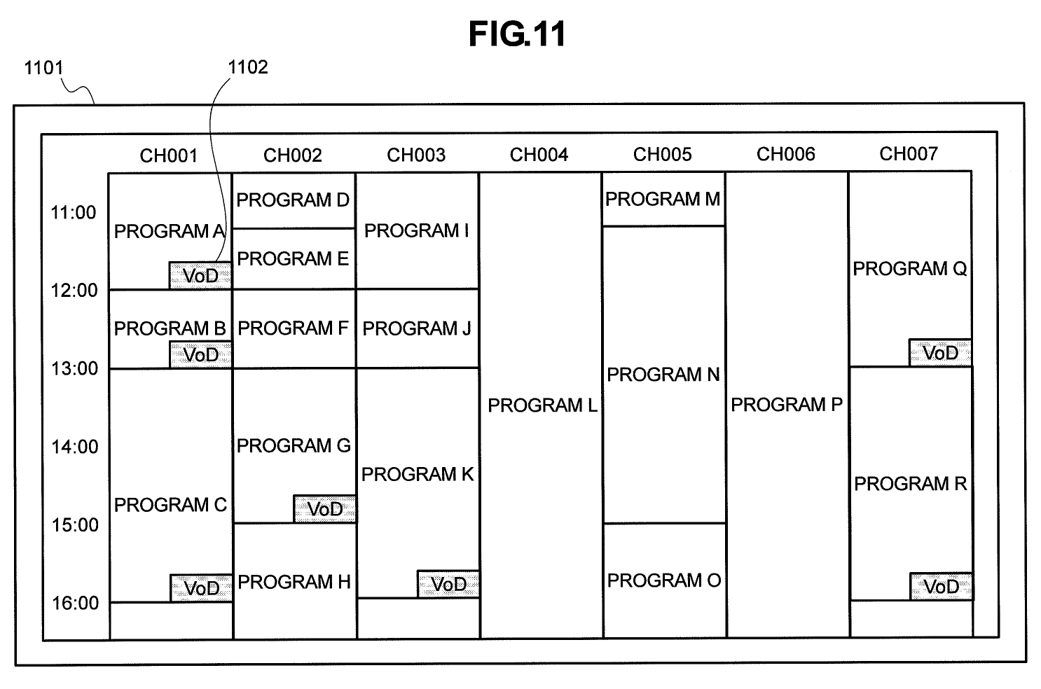

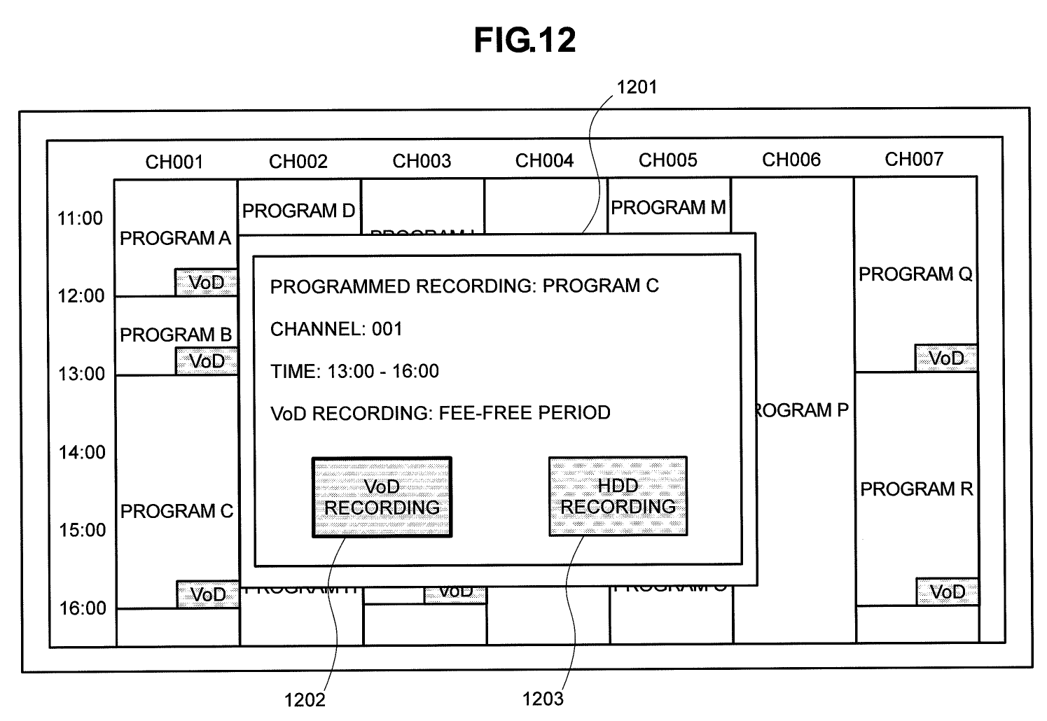

The same process as described above may be performed to display the screen 801 before the start of the recording. A time point before the start of the recording means, for example, a time point to display an electronic program guide or a time point to display an operation screen for programmed recording. As an example of the same process performed at the time point to display the electronic program guide, steps 203 and 204 are performed before or when the electronic program guide is displayed, the sign “VoD enabled” is displayed on a corresponding program present in the electronic program guide when it is determined that the VoD enabling process is possible in step 205. FIG. 11 shows an example of a screen of the electronic program guide. Reference numeral 1101 denotes the electronic program guide. When content is VoD enabled (when the content can be replaced with VoD content), a sign “VoD” (indicated by reference numeral 1102) is displayed on a program corresponding to the content. As an example of the same process performed at the time point to display the operation screen for the programmed recording, steps 203 and 204 are performed before or when the operation screen for the programmed recording is displayed, and a sign indicating the content is VoD enabled is displayed on the operation screen for the programmed recording when it is determined that the VoD enabling process is possible in step 205. FIG. 12 shows an example of the operation screen for the programmed recording. Reference numeral 1201 denotes the operation screen for the programmed recording. For example, when a program is focused on the electronic program guide and a programmed recording button is pressed, the operation screen is displayed. Reference numeral 1202 denotes a VoD recording button. When the VoD recording button is pressed, VoD enabled information (corresponding to the contents C to E shown in FIG. 9) is registered on a recorded content list as if the content were recorded in the HDD. Reference numeral 1203 denotes a HDD recording button. When the content is not VoD enabled (when the content cannot be replaced with VoD content), the VoD recording button is not displayed (only the HDD recording button is displayed). In this case, instead of the recorded content, the broadcast content is used to determine whether or not the VoD enabling process is possible in step 205. In addition, meta data of the broadcast content is used to perform the comparison of the meta data, instead of meta data of the recorded content. Since there is a possibility that the content cannot be acquired before broadcast, steps 602 to 607 may not be performed.

In the configuration described above, an operation similar to the recording can be realized in the VoD enabling process while content is not recorded in the HDD. The memory area of the HDD can be saved, and usability is improved.

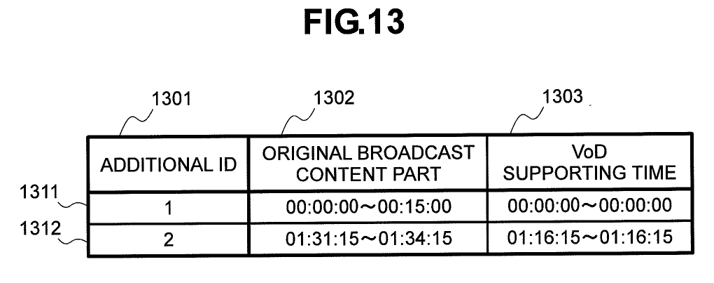

As an example other than the abovementioned examples, only a difference between a VoD enabled content and a broadcast content is recorded. In this method, the broadcast station provides information that allows for determination of a difference between the broadcast content and VoD content. An example of this method is shown in FIG. 13. FIG. 13 is a diagram showing a table indicating additional data of the broadcast content provided through the electronic program guide. The additional data is not included in the VoD content. Reference numeral 1301 denotes an ID indicating an additional broadcast content portion. Reference numeral 1302 denotes information indicating a reproduction time of the additional broadcast content portion. The start reproduction time of the content indicates “0”. The information denoted by 1302 is represented by hours, minutes, and seconds. Reference numeral 1303 denotes information indicating the position of the additional broadcast content portion indicated by the information 1302 in the VoD content. An additional broadcast content portion 1311 ranging from a start portion of the broadcast content to a broadcast content portion corresponding to a reproduction time of 15 minutes corresponds to a start portion of the VoD content. When an original broadcast content portion needs to be recorded, only the additional broadcast content portion corresponding to the time indicated by the information 1302 is recorded. In order to reproduce the same content as the broadcast content by using the VoD content, the recorded additional broadcast content portion 1311 is first reproduced. Then, the VoD content is reproduced. Similarly, an additional broadcast content portion 1312 is reproduced when the reproduction time of the VoD content reaches 1 hour 16 minutes 15 seconds. In this example, the original broadcast content portion is reproduced for 3 minutes. In this way, a portion of the VoD content is replaced with the original broadcast content portion, and the original broadcast content portion is reproduced at a VoD supporting time (indicated by reference numeral 1303 in FIG. 13). Only the difference between the broadcast content and the VoD content is recorded in order to reproduce the same content as the original broadcast content. When the portion of the VoD content corresponding to the VoD supporting time is replaced with the recorded original broadcast content portion, the recorded original broadcast content portion is reproduced. Therefore, the same content as the original broadcast content can be reproduced.

In addition, when the contents are different in image quality from each other and are the same in other respects as each other in the process for comparing the meta data in step 601, the determination may be made through an inquiry to the user or based on user settings.

Furthermore, when a plurality of the VoD servers is provided, a user interface may be displayed to allow the user to select any of the VoD servers in order to perform the VoD enabling process. Alternatively, the highest reliable VoD server may be automatically selected based on reliability information obtained from another server or the like.

What is claimed is:

1. A recorder comprising:
a recording section for recording content; and
a VoD section for comparing the content recorded by the recording section with content provided through a video-on-demand service and removing the content recorded by the recording section based on the comparison.

2. The recorder according to claim 1, further comprising:
a receiving section for receiving the content provided through the video-on-demand service; and
a reproduction content selector for allowing the receiving section to receive and reproduce the content provided through the video-on-demand service when the reproduction content selector receives an instruction for reproduction of the content removed by the VoD section.

3. The recorder according to claim 1, wherein
the VoD section requests a notification indicating suspension of the video-on-demand service for the content to be provided through the video-on-demand service.

4. The recorder according to claim 1, wherein
when the VoD section receives the notification indicating the suspension of the video-on-demand service for the content to be provided through the video-on-demand service, the content or a corresponding content is recorded.

5. The recorder according to claim 1, wherein
the VoD section compares meta data of the content recorded by the recording section with meta data of the content provided through the video-on-demand service.

6. The recorder according to claim 5, wherein
the VoD section compares a broadcast date, broadcast time, and broadcast channel that are included in the meta data of the content recorded by the recording section with a broadcast date, broadcast time, and broadcast channel that are included in the meta data of the content provided through the video-on-demand service, or compares a content ID included in the meta data of the content recorded by the recording section with a content ID included in the meta data of the content to be provided through the video-on-demand service.

7. The recorder according to claim 5, wherein
when the meta data of the content recorded by the recording section does not match the meta data of the content provided through the video-on-demand service, the VoD section compares video data of the recorded content with video data of the content provided through the video-on-demand service and/or compares audio data of the recorded content with audio data of the content provided through the video-on-demand service.

8. The recorder according to claim 1, wherein
the VoD section switches a process for the comparison to another comparison process based on whether or not the content provided through the video-on-demand service is free.

9. The recorder according to claim 1, wherein
when the content recorded by the recording section matches the content provided through the video-on-demand service, the VoD section removes the content recorded by the recording section, and
when the content recorded by the recording section does not match the content provided through the video-on-demand service, the VoD section requests that the recorded content is provided through the video-on-demand service.

10. The recorder according to claim 1, wherein
when a first portion of the content recorded by the recording section matches a first portion of the content provided through the video-on-demand service, and when a second portion of the content recorded by the recording section does not matches a second portion of the content provided through the video-on-demand service, the VoD section removes only the first portion of the content recorded by the recording section.

11. The recorder according to claim 1, wherein
the VoD section compares a broadcast content with a video-on-demand enabled content and displays the fact that video-on-demand is possible before the recording is performed.

12. The recorder according to claim 11, wherein
the VoD section performs a function for recording the broadcast content to record data on a method for starting to reproduce the content provided through the video-on-demand service without recording the broadcast content in a recording medium.

13. The recorder according to claim 11, wherein
the recording section records only a portion that is described in information indicating a difference between the broadcast content and the video-on-demand enabled content and attached to the broadcast content, the portion being provided only through broadcast.

14. A receiver comprising:
a receiving section for receiving a broadcast content; and
a VoD section for comparing the broadcast content received by the receiver with a video-on-demand enabled content, and displaying the fact that video-on-demand is possible based on the comparison before the recording is performed.

15. The receiver according to claim 14, wherein
the VoD section records data on a method for starting to reproduce the content provided through the video-on-demand service.
